(19) United States
(12) Patent Application Publication
(10) Pub. No.: US 2012/0107585 A1
(43) Pub. Date: May 3, 2012

(54) Ceramic Composite Based on Beta-Eucryptite and an Oxide, and Process of Manufacturing Said Composite

(75) Inventors: Laurent BLANCHARD, Mouans-Sartoux (FR); Gilbert FANTOZZI, Meyzieu (FR); Aurélien PELLETANT, Villeurbanne (FR); Helen REVERON, Lyon (FR); Jérôme CHEVALIER, Rillieux La Pape (FR)

(73) Assignees: Centre National De La Recherche Scientifique (CNRS), Paris (FR); THALES, Neuilly-sur-Seine (FR)

(21) Appl. No.: 13/096,905

(22) Filed: Apr. 28, 2011

(30) Foreign Application Priority Data
Apr. 30, 2010 (FR) 10 01864

(51) Int. Cl. B32B 7/02; C04B 35/64; C04B 35/19

(52) U.S. Cl. 428/212; 501/153; 501/134; 264/681

(57) ABSTRACT

A composite having a coefficient of thermal expansion less than 1.3×10⁻⁶ K⁻¹ is a sintered ceramic based on an oxide and on β-eucryptite crystals having a β-eucryptite content of less than 55% by weight (69% by volume).

### CROSS-REFERENCE TO RELATED APPLICATION

This application claims priority to foreign French patent application No. FR 1001864, filed on Apr. 30, 2010, the disclosure of which is incorporated by reference in its entirety.

### FIELD OF THE INVENTION

The field of the invention is that of composites suitable for producing optical components for space applications, such as mirrors, and to the production of optical structures (also called structural components), the function of which is to position and support the optical components.

### BACKGROUND

The general trend in space observation is to increase the diameter of mirrors both for future scientific missions for observing the universe and for observing the Earth, for example from a geostationary orbit. Thus, in the near future, there will be a need for extremely stable composites, allowing very high degrees of lightening to be achieved, while still being rigid and strong, enabling the production of mirrors with diameters greater than 2 m and with weights per unit area of less than 25 kg/m⁻². To obtain dimensionally stable mirrors, composites are sought that have a very low CTE (coefficient of thermal expansion) around the ambient temperature and/or below ambient temperature for cryogenic applications (for example for infrared observation).

Optical structures such as telescope structures are themselves also subjected to very stringent requirements in terms of dimensional stability in order to be able to guarantee image quality. In addition, their increasing size requires composites enabling high degrees of lightening to be achieved, while still being rigid and strong.

For such applications, composites having good dimensional stability, i.e. a positive coefficient of thermal expansion of less than 1.3×10⁻⁶ K⁻¹, are known. For example, there is a composite called Zerodur corresponding to a registered trade mark. Zerodur is a glass-ceramic widely used for producing mirrors for use on Earth and in space. It has a very low coefficient of thermal expansion at room temperature (2×10⁻⁸ K⁻¹), excellent optical properties and a low density (d=2.54). However, its modest mechanical properties greatly limit its lightening capabilities. The minimal mass per unit area of mirrors made of Zérodur© are around 35-40 kg/m⁻². It is somewhat unrealistic to envisage Zerodur being used for space mirrors having diameters greater than 1.5 m.

### SUMMARY OF THE INVENTION

The present invention provides a composite exhibiting good dimensional stability compatible with space applications and also good mechanical properties for enabling large optical components and structures to be produced.

The invention also provides a composite of this type that can be obtained from a simple manufacturing process.

For this purpose, one subject of the invention is a composite having a coefficient of thermal expansion less than 1.3×10⁻⁶ K⁻¹, said composite being a sintered ceramic based on an oxide and on β-eucryptite crystals, the β-eucryptite content of which is less than about 55% by weight (about 70% by volume), the oxide being able to be sintered at a temperature below the melting point of β-eucryptite, and having a Young's modulus of greater than 100 GPa and a measured flexural strength of greater than 100 MPa.

Advantageously, the β-eucryptite has a grain size of greater than about 6 μm.

Advantageously, the β-eucryptite grains are microcracked.

In a first embodiment, the oxide is alumina.

Advantageously, the oxide is obtained from the sintering of nanoscale alumina crystals.

In a second embodiment, the oxide is zirconia.

Advantageously, the zirconia is doped with a tetravalent element, for example cerium oxide.

Another subject of the invention is an optical component intended for space applications, made of a composite according to the invention.

Another subject of the invention is a structural component intended for positioning and supporting at least one optical component intended for space applications, the structural component being made of a composite according to the invention.

Another subject of the invention is an optical device comprising an optical component and the structural component, both being made of a composite according to the invention.

Advantageously, the optical device comprises an optical component and the structural element, both being made of the same composite.

Another subject of the invention is a process for manufacturing a composite according to the invention, comprising a step of producing a first powder blend, in which a powder of an oxide in crystalline form is blended with a powder of β-eucryptite in crystalline form, and a heat treatment step, for heating an oxide and a β-eucryptite composite obtained from the first blend, in order to sinter the oxide.

Advantageously, the heat treatment step consists in heating the oxide and the β-eucryptite composite to a sintering temperature below the melting point of β-eucryptite under the heat treatment conditions.

Advantageously, the process comprises a step of manufacturing the β-eucryptite powder, comprising:
a step of producing a blend of lithium carbonate powder, alumina powder and silica powder in suitable proportions in order to obtain β-eucryptite;
a step of calcining a powder obtained from the blend, in order to obtain β-eucryptite; and
a heat treatment step for causing the β-eucryptite grains to grow and crack.

Advantageously, the calcining step comprises a step of raising the temperature up to a maximum temperature followed by a step of lowering the temperature starting immediately after the temperature has reached the maximum temperature.

### DETAILED DESCRIPTION

Using a composite based on an oxide (having a positive coefficient of thermal expansion) capable of being sintered at a temperature below the melting point of β-eucryptite, a composite exhibiting dimensional stability compatible with space applications is easily obtained. It is sufficient to blend oxide and β-eucryptite particles and to heat the blend to a temperature enabling the oxide to be sintered. Moreover, by choosing an oxide having a high Young's modulus and a high strength, a composite is obtained that has mechanical properties appropriate for optical applications in the space field and more particularly for producing optical components with a diameter greater than 2 m and appropriate optical structures.

The composite according to the invention is one having a coefficient of thermal expansion of less than 1.3×10⁻⁶ K⁻¹. The composite according to the invention is a sintered ceramic composite based on an oxide and crystalline β-eucryptite particles. β-Eucryptite is a lithium aluminosilicate, widely referred to by the acronym LAS, the composition of which is the following: (Li₂O)ₓ (Al₂O₃)_{y} (SiO₂)_{z} where x, y and z are the respective molar fractions of lithium oxide Li₂O, alumina Al₂O₃ and silica SiO₂. The respective molar fractions of β-eucryptite are the following: x=1, y=1 and z=2.

β-Eucryptite in crystalline form has the particular feature of having a slightly negative coefficient of thermal expansion of around −0.4×10⁻⁶ K⁻¹, i.e. it contracts when the temperature is raised. The coefficient of thermal expansion of β-eucryptite in crystalline form varies depending on the constituent grain size. The variation in the coefficient of thermal expansion stems from the cracking of the β-eucryptite grains. For example, it is possible to obtain a coefficient of thermal expansion of −6.1×10⁻⁶ K⁻¹ for a grain size of around 7 μm and a coefficient of thermal expansion of −10.9×10⁻⁶ K⁻¹ for a grain size of around 13 μm (K corresponding to Kelvin). β-Eucryptite in amorphous form has a higher coefficient of thermal expansion than when in the crystalline form and has to be avoided.

A composite comprising β-eucryptite in crystalline form in a sintered oxide matrix (the coefficient of thermal expansion of which is positive) has a lower coefficient of thermal expansion than that of the sintered oxide matrix.

An oxide capable of being sintered at a temperature below the melting point of β-eucryptite, and having by itself good mechanical properties, is chosen.

By choosing an oxide capable of being sintered at a temperature below the melting point of β-eucryptite it is possible to obtain a composite of dimensional stability suitable for optical applications in the space field by means of a very simple manufacturing process. A composite of dimensional stability suitable for optical applications in the space field is one having a coefficient of thermal expansion of less than 1.3×10⁻⁶ K⁻¹.

Advantageously, the manufacturing process below is used.

A first powder blend is produced from a powder of β-eucryptite in crystalline form and an oxide powder in crystalline form (having the characteristics listed above).

The β-eucryptite and oxide relative proportions and grain sizes are adjusted according to the desired coefficient of thermal expansion of the final composite. These are chosen so that the coefficient of thermal expansion of the final composite is less than 1.3×10⁻⁶ K⁻¹. The lower the desired coefficient of thermal expansion, the higher the proportion of β-eucryptite. Likewise, the lower the desired coefficient of thermal expansion, the larger the β-eucryptite grain size. If it is desired to use the composite as an optical component, the relative proportions are preferably chosen in such a way that the coefficient of thermal expansion of the final composite is less than 1.3×10⁻⁶ K⁻¹ and advantageously as close as possible to zero.

If it is desired to use the composite as a structural component, the relative proportions are preferably chosen in such a way as to maximize the mechanical properties, while still maintaining a coefficient of thermal expansion of less than 1.3×10⁻⁶ K⁻¹.

The composite obtained makes it possible to produce an optical device, for example a telescope, comprising at least one optical structure and at least one optical component supported by the optical structure that are produced from identical materials. This makes it possible to obtain a thermal optical device, that is to say one which all the components deform with temperature in a similar manner.

If it is desired to use the composite as a structural component (or substrate) and as an optical component, within one and the same device, the coefficient of thermal expansion of all the components is advantageously adjusted to the same single value of less than 1.3×10⁻⁶ K⁻¹.

The step of blending the oxide with the β-eucryptite is, for example, a dispersion step, for example using a rotary ball mill. The slip thus obtained is then moulded. It is thus possible to produce various shapes, such as tubes or simple plates, by choosing a suitable mould shape.

The composite obtained is dried. The drying is for example carried out in an oven. Advantageously, the drying step is carried out after the part has been demoulded.

As a variant, the slip obtained during the dispersion step is dried (for example by spray drying and granulation and addition with binders and plasticizers) and then pressed using a cold or hot pressing method.

As a variant, the blend is not produced in solution but by dry processing, for example in a rotary ball mill, and then pressed by a cold or hot pressing method.

At this stage, the part obtained by casting or cold pressing may be machined so as to give it a complex geometry. For example, it is possible to make cavities within the green body so as to lighten the part.

The composite is then sintered by carrying out a heat treatment. The heat treatment consists in heating the oxide and the β-eucryptite composite to a sintering temperature, optionally with the assistance of gas pressure or mechanical pressure. The rise in temperature may also be achieved by radiative or pulse-current or microwave heating. The sintering temperature is chosen so as to sinter the oxide but not to melt the β-eucryptite. In other words, the sintering temperature is below the melting point of β-eucryptite under the chosen operating conditions (in terms of pressure, rate of temperature rise, current, hold time at the sintering temperature). The sintering conditions depend upon the oxide chosen. As an example, the melting point of β-eucryptite is around 1340° C. under natural sintering conditions. The sintering temperature is for example less than 1340° C.

It is possible to produce very large parts since a casting or pressing technique followed by natural sintering can be used.

The sintering of the oxide is followed by a step of cooling the composite obtained. The part obtained can then be machined, ground and, in the case of a mirror, polished.

The composite obtained after this process forms a part which may be an optical component for example a mirror, or an optical structure, for example a telescope structure, capable of supporting an optical component. The nature of the part obtained depends on the shape of the mould used, on any lightening achieved, on the optional machining and polishing operations carried out, and also on the relative proportions of the oxide and β-eucryptite powders in the first blend.

The composite obtained is a sintered ceramic composite based on an oxide and on β-eucryptite. The sintering temperature is below the melting point of β-eucryptite. In this way it is ensured that the β-eucryptite remains in crystalline form while the oxide is being sintered, thereby making it possible to obtain a coefficient of expansion of less than 1.3×10⁻⁶ K⁻¹.

Composites having a coefficient of thermal expansion suitable for space applications with a minimal amount of β-eucryptite are obtained. Moreover, it is not necessary to provide a heat treatment step after the sintering in order to crystallize the β-eucryptite.

By choosing an oxide having good mechanical properties (a Young's modulus greater than 100 GPa and preferably greater than 200 GPa, and a measured flexural strength greater than 100 MPa, preferably greater than 500 MPa), a composite having mechanical properties suitable for space applications, i.e. having a Young's modulus greater than 100 GPa and a flexural strength greater than 100 MPa, is obtained. The mechanical properties and the dimensional stability of β-eucryptite are particularly advantageous for the desired applications. The optical components necessarily having the coefficient of thermal expansion close to zero must be based on a composite having a higher content of β-eucryptite than that for producing structural components. This is because the coefficient of thermal expansion may be higher than that of the optical components. In contrast, the constraints on the mechanical properties are greater in the case of the structural components. Now, the simple fact of adding less β-eucryptite in the oxide matrix improves the mechanical properties thereof.

Moreover, oxides are easily sintered. After the sintering, a fully dense composite is therefore obtained. Now, the density is an essential element for achieving good mechanical properties. In addition, by obtaining a fully dense composite the part can be polished directly. This avoids having to add an additional layer such as an SiC layer conventionally deposited by CVD on the SiC mirror substrates.

Two examples of oxides that can be used in the context of our invention will now be described. These are, on the one hand, alumina (Al₂O₃) and, on the other hand, a zirconia doped with an oxide of at least one tetravalent element. The oxide of a tetravalent element is for example cerium oxide (Ce-TZP, also called cerium-stabilized zirconia or Ce-ZrO₂). Zirconias having a cerium oxide molar content of less than or equal to 20% may be used. These materials are chosen for the reasons explained in this patent application.

Natural sintering of alumina and cerium-stabilized zirconia is conceivable at a temperature below the melting point of β-eucryptite (around 1340° C. under natural sintering conditions). It is advantageous to use the powder in which the alumina particles are of nanoscale size since the melting point of nanoscale alumina is lower. Alumina particles with a size of less than 1 μm may generally be used. Advantageously, the β-eucryptite powder in which the crystalline β-eucryptite particles are larger in size than 6 μm is used.

Moreover, the alumina and the zirconias doped with an oxide of a tetravalent element have low coefficients of thermal expansion, making it possible to obtain composites having coefficients of thermal expansion of less than 1.3×10⁻⁶K⁻¹. The coefficient of thermal expansion of alumina at room temperature is around 8×10⁻⁶ K⁻¹. The coefficient of thermal expansion of 16-Ce-TZP cerium-stabilized zirconia is around 11×10⁻⁶ K⁻¹. 16-Ce-TZP zirconia is the cerium-stabilized zirconia having a cerium oxide molar content of 16%.

The alumina and the zirconias doped with an oxide of tetravalent element posses good mechanical properties.

The alumina has a Young's modulus of around 400 GPa and a measured flexural strength of around 400 MPa. The alumina also has a toughness of around 4 MPa/m^{1/2}. Toughness is a measure of the capability of a material to absorb energy when it is subjected to the cracking situation, corresponding to a crack affecting the material not being able to propagate. An alumina and β-eucryptite ceramic composite may be obtained that has a zero coefficient of thermal expansion, a Young's modulus of around 100 GPa and a moderate strength (flexural strength) of about 100 MPa.

16Ce-TZP has a Young's modulus around 215 GPa and a measured flexural strength of around 600 MPa. 16Ce-TZP zirconia also has a relatively high toughness, possibly up to 11 MPa/m^{1/2}.

Furthermore, alumina and cerium-stabilized zirconia powders are commercially available.

In comparison, for example, with yttrium-doped zirconias, zirconias doped with oxides of tetravalent elements, and more particularly doped with cerium oxide, have the advantage of not being degraded in the presence of moisture. This enhances the dimensional stability of the material and therefore of the present composites.

Among the oxides of at least one tetravalent element that can also be used, mention may be made of titanium oxide and titanium cerium oxide.

The steps of an example of a process for synthesizing the β-eucryptite will now be described. Of course, the β-eucryptite may be obtained by any other process for synthesizing nanoscale or micron-size β-eucryptite.

Lithium carbonate Li₂CO₃, alumina Al₂O₃ and silica SiO₂ powders are blended in suitable proportions for obtaining β-eucryptite. For this purpose, the lithium carbonate, alumina and silica powders are blended in respective proportions by weight of these elements equal to 24.96%, 34.45%, 40.59%.

The blend obtained is put into aqueous solution, for example containing 50% by weight of the blend. Optionally, a dispersing agent is introduced into the solution, for example Darvan C.

For example, a solution is produced in which 50% of the weight thereof results from the previously obtained blend and 0.15% of the weight thereof corresponds to a dispersing agent. The solution is then dispersed. The dispersing step is, for example, carried out by means of a rotary ball mill with zirconia balls for 24 h.

The slip obtained is then dried. The drying operation is for example carried out in an oven at 110° C. This operation is continued until the weight loss is zero.

The process then includes a step of calcining the dried powder. The function of the calcining step is to create the conditions for obtaining a solid-state reaction between the lithium carbonate Li₂CO₃, alumina Al₂O₃ and silica SiO₂ powders so as to obtain the β-eucryptite. Advantageously, the calcining step comprises a step of raising the temperature up to a maximum temperature Tₘₐₓ followed by a step of lowering the temperature as soon as the maximum temperature is reached. In other words, the hold time at the maximum temperature is zero. The Applicant has found that this process prevents the β-eucryptite obtained from densifying or sintering, something which is not the case when the powder is held at the maximum temperature for a non-zero time. Densification of the β-eucryptite grains is avoided so as to make it easier to mill the powder obtained. As a variant, the calcination may be carried out with a hold at the maximum temperature for a non-zero time. This is advantageous when it is desired to use a β-eucryptite of larger size. The dried powder is, for example, calcined in a furnace according to the following protocol: temperature rise to 1050° C. at a rate of 5° C./min and then, as soon as this temperature is reached, cooling at a rate of 5° C./min down to 200° C. and natural cooling.

The calcined powder is then milled (in aqueous solution or by dry milling) in order to obtain nanoscale or micron-size particles. The milling is carried out for example in an attrition mill or in a rotary ball mill.

For example, an aqueous solution having a solids content of 40% by weight is obtained. The aqueous solution is then milled in an attrition mill for 6 h at 500 revolutions per minute.

The solution is then dried.

The drying is carried out for example by means of a rotary evaporator at 70° C. under a pressure of 300 mbar. As a variant, the slip obtained from the attrition milling is cast.

Thus, an aqueous solution having a solids content of 40% is obtained. The aqueous solution is then dispersed by means of a rotary ball mill using zirconia balls for 24 h.

The slip obtained is then cast. The green bodies thus obtained are dried, for example in an oven at 50° C. This operation is continued until the weight loss is zero.

The dried green bodies are then heat treated at 1300° C. for a non-zero time. Thus, for example, β-eucryptite grains with a grain size of 7 μm are obtained after a heat treatment at 1300° C. for 6 h. In addition, these grains exhibit microcracking. As a variant, the powder obtained from the calcining is milled with no attrition and heat treated at 1300° C. for a non-zero time.

Finally, the heat-treated β-eucryptite ceramics thus obtained are milled and screened.

It is possible for example to obtain β-eucryptite aggregates having a size between 7 μm and 20 μm, formed from 7 μm grains for a heat treatment at 1300° C. for 6 h.

1. A composite having a coefficient of thermal expansion less than 1.3×10⁻⁶ K⁻¹, comprising:
a sintered ceramic based on an oxide and on β-eucryptite crystals, having a β-eucryptite content of less than about 55% by weight.

2. The composite of claim 1, having a β-eucryptite grain size which is greater than about 6 μm.

3. The composite of claim 2, the β-eucryptite grains of which are microcracked.

4. The composite of claim 1, in which the oxide is alumina.

5. The composite according to claim 4, in which the oxide is obtained from the sintering of nanoscale alumina crystals.

6. The composite according to claim 1, in which the oxide is zirconia.

7. The composite according to claim 6, in which the oxide is zirconia doped with an oxide of at least one tetravalent element.

8. The composite according to claim 7, in which the zirconia is doped with a cerium oxide.

9. An optical component intended for space applications, said component being made of a composite according to claim 1.

10. A structural component intended for positioning and supporting at least one optical component intended for space applications, the structural component being made of a composite according to claim 1.

11. An optical device comprising:
an optical component intended for space applications, said component being made of a composite according to claim 1, and
a structural component intended for positioning and supporting at least one said optical component, the structural component being made of a composite according to claim 1.

12. An optical device according to claim 11, in which said optical component and the structural component are made of the same composite.

13. A process for manufacturing a composite according to claim 1, comprising:
a step of producing a first powder blend, in which a powder of an oxide in crystalline form is blended with a powder of β-eucryptite in crystalline form, and
a heat treatment step, for heating an oxide and a β-eucryptite composite obtained from the first blend, in order to sinter the oxide.

14. The manufacturing process according to claim 13, in which the heat treatment consists in heating the oxide and the β-eucryptite composite to a sintering temperature below the melting point of β-eucryptite under the heat treatment conditions.

15. The manufacturing process according to claim 13, further comprising a step of manufacturing the β-eucryptite powder, said step of manufacturing the β-eucryptite powder comprising:
a step of producing a blend of lithium carbonate powder, alumina powder and silica powder in suitable proportions in order to obtain β-eucryptite;
a step of calcining a powder obtained from the blend, in order to obtain β-eucryptite; and
a heat treatment step for causing the β-eucryptite grains to grow and crack.

16. The manufacturing process according to claim 15, in which the calcining step comprises a step of raising the temperature up to a maximum temperature followed by a step of lowering the temperature starting immediately after the temperature has reached the maximum temperature.
